(19) United States
(12) Patent Application Publication
(10) Pub. No.: US 2016/0161629 A1
(43) Pub. Date: Jun. 9, 2016

(54) Monitoring Carbon Dioxide Flooding Using Nuclear Magnetic Resonance (NMR) Measurements

(71) Applicant: SCHLUMBERGER TECHNOLOGY CORPORATION, Sugar Land, TX (US)

(72) Inventors: Mohammed Badri, Al-Khobar (SA); Reza Taherian, Missouri City, TX (US)

(21) Appl. No.: 14/886,187

(22) Filed: Oct. 19, 2015

Related U.S. Application Data
(60) Provisional application No. 62/087,993, filed on Dec. 5, 2014.

(51) Int. Cl. G01V 3/32; E21B 49/00

(52) U.S. Cl. CPC G01V 3/32; E21B 49/008

(57) ABSTRACT

A NMR logging tool is provided and disposed at some desired depth in a wellbore penetrating a subsurface formation. A first set of NMR measurements is made over a desired depth range and depth of investigation, wherein the first set of NMR measurements includes a first NMR signal intensity. Supercritical carbon dioxide is injected into the formation and a second set of NMR measurements is made over the desired depth range and depth of investigation, wherein the second set of NMR measurements includes a second NMR signal intensity. The first NMR signal intensity is compared to the second NMR signal intensity and one or more properties of the formation are inferred using the compared NMR measurements. A magnetic field gradient that varies a static magnetic field along a desired spatial dimension of a region of investigation may be provided to map a rate of fluid movement.

### CROSS-REFERENCE TO RELATED APPLICATIONS

This application claims, under 35 U.S.C. §119(e), priority to and the benefit of U.S. Provisional Application No. 62/087,993, filed Dec. 5, 2014.

### BACKGROUND OF THE DISCLOSURE

Nuclear Magnetic Resonance (NMR) tools used for well-logging and downhole fluid characterization measure the response of nuclear spins in formation fluids to applied magnetic fields. Downhole NMR tools typically have a permanent magnet that produces a static magnetic field at a desired test location (e.g., where the fluid is located). The static magnetic field produces a magnetization in the fluid. The magnetization is aligned along the direction of the static field. The magnitude of the induced magnetization is proportional to the magnitude of the static field. A transmitter antenna produces a time-dependent radio frequency magnetic field that has a component perpendicular to the direction of the static field. The NMR resonance condition is satisfied when the radio frequency is equal to the Larmor frequency, which is proportional to the magnitude of the static magnetic field and the gyromagnetic ratio of the particular nuclear spin. The radio frequency magnetic field produces a torque on the magnetization vector that causes it to rotate about the axis of the applied radio frequency field. The rotation results in the magnetization vector developing a component perpendicular to the direction of the static and time varying magnetic fields. The magnetization vector then precesses around the static field at the Larmor frequency. At resonance between the Larmor and transmitter frequencies, the magnetization is tipped to the transverse plane (i.e., a plane normal to the static magnetic field vector). A series of radio frequency pulses are applied to generate spin echoes that are measured with the antenna.

NMR measurements can be used to estimate, among other things, formation porosity. For example, the area under the curve of a T2 distribution for a NMR measurement can be equated to or at least provides an estimate of the NMR-based porosity. The T2 distribution may also resemble the pore size distribution in water-saturated rocks. The raw reported porosity is provided by the ratio of the initial amplitude of the raw decay and the tool response in a water tank. This porosity is independent of the lithology of the rock matrix.

Another formation parameter is permeability. The typical laboratory technique for direct permeability measurement is to flow a fluid through a formation sample, thereby inducing a pressure gradient AP across the sample and measuring the fluid flux q. For a fluid of unit viscosity, these quantities are related to the sample permeability, k, through Darcy's law:

$$k = \frac{q}{Δ P} \qquad ( 1 )$$

Thus, the permeability of the sample can be determined if the pressure gradient and the fluid flux are known. If the fluid is other than water, then the right hand side of Eq. (1) is multiplied by the fluid viscosity.

Enhanced oil recovery, employed after the primary recovery phase for a reservoir is essentially exhausted, may include injecting external fluid such as water or gas into the reservoir through injection wells located in rock that has fluid communication with one or more production wells. The purpose of such enhanced recovery is to maintain reservoir pressure and to displace hydrocarbons toward a production wellbore. The most common enhanced oil recovery techniques are gas injection and water flooding.

### SUMMARY

A NMR logging tool is provided and disposed at some desired depth in a wellbore penetrating a subsurface formation. A first set of NMR measurements is made over a desired depth range and depth of investigation, wherein the first set of NMR measurements includes a first NMR signal intensity. Supercritical carbon dioxide is injected into the formation and a second set of NMR measurements is made over the desired depth range and depth of investigation, wherein the second set of NMR measurements includes a second NMR signal intensity. The first NMR signal intensity is compared to the second NMR signal intensity and one or more properties of the formation are inferred using the compared NMR measurements. A magnetic field gradient that varies a static magnetic field along a desired spatial dimension of a region of investigation may be provided to map a rate of fluid movement.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. Embodiments are described with reference to the following figures. The same numbers are generally used throughout the figures to reference like features and components.

FIG. 1 shows a prior art nuclear magnetic resonance logging tool;

FIG. 2 is a schematic drawing of a NMR instrument capable of making high pressure/high temperature (HPHT) measurements, in accordance with the present disclosure;

FIG. 3 is a schematic drawing of an oil field having an injection well, a production well, and a monitoring well, in accordance with the present disclosure;

FIG. 4 is a plot of NMR signal intensities versus depth, in accordance with the present disclosure;

FIG. 5 is a plot of diffusion versus T2 relaxation times, in accordance with the present disclosure;

FIG. 6 is a plot of NMR signals obtained from various axial distances along a region of investigation, in accordance with the present disclosure;

FIG. 7 is a plot of relative permeability versus oil saturation for two example “slices” along the region of investigation, in accordance with the present disclosure;

FIG. 8A is a schematic drawing of a NMR instrument disposed in a monitoring well showing uniform fluid dispersion, in accordance with the present disclosure;

FIG. 8B is a schematic drawing of a NMR instrument disposed in a monitoring well showing non-uniform fluid dispersion, in accordance with the present disclosure;

FIG. 9 is a plot of NMR signal versus the volume of supercritical carbon dioxide, in accordance with the present disclosure; and

FIG. 10 is a flowchart for using nuclear magnetic resonance (NMR) logging in injection, observation, and production wells to monitor carbon dioxide (CO₂) concentrations during CO₂ flooding operations, in accordance with the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Some embodiments will now be described with reference to the figures. Like elements in the various figures may be referenced with like numbers for consistency. In the following description, numerous details are set forth to provide an understanding of various embodiments and/or features. However, it will be understood by those skilled in the art that some embodiments may be practiced without many of these details and that numerous variations or modifications from the described embodiments are possible. As used here, the terms “above” and “below”, “up” and “down”, “upper” and “lower”, “upwardly” and “downwardly”, and other like terms indicating relative positions above or below a given point or element are used in this description to more clearly describe certain embodiments. However, when applied to equipment and methods for use in wells that are deviated or horizontal, such terms may refer to a left to right, right to left, or diagonal relationship, as appropriate. It will also be understood that, although the terms first, second, etc. may be used herein to describe various elements, these elements should not be limited by these terms. These terms are only used to distinguish one element from another.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

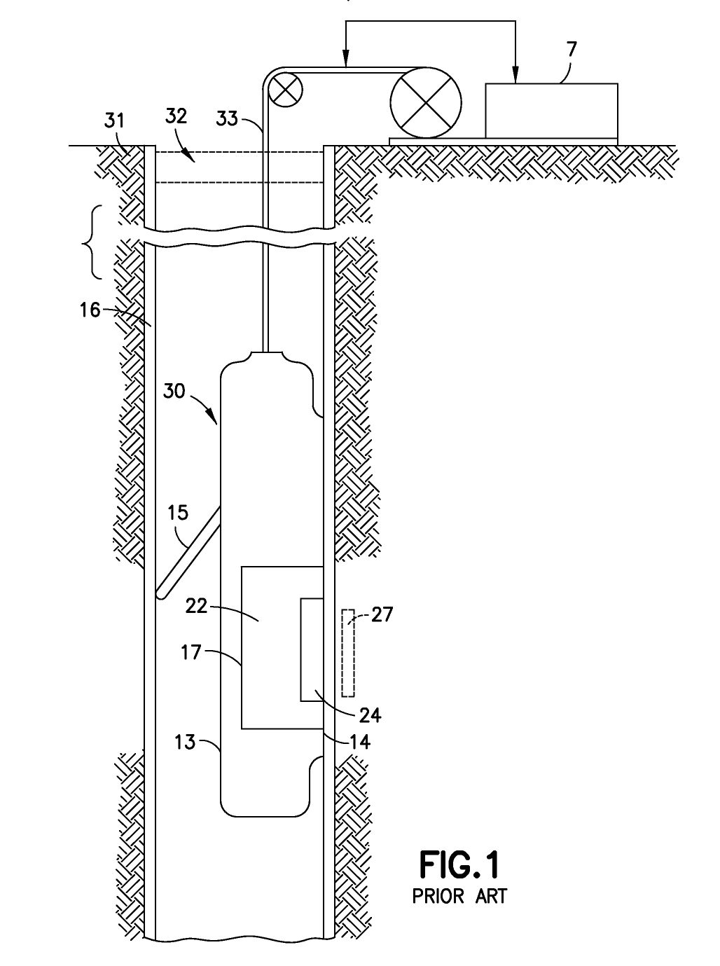

FIG. 1 shows an embodiment of a prior art downhole nuclear magnetic resonance device suitable for use as described below. It is understood that other types of NMR tools could be used. Referring to FIG. 1, there is shown an apparatus that can be used to investigate subsurface formations 31 traversed by a borehole 32. A magnetic resonance investigating apparatus or logging device 30 is suspended in the borehole 32 on an armored cable 33, the length of which substantially determines the relative depth of the device 30. The length of cable 33 is controlled by suitable means at the surface such as a drum and winch mechanism (not shown). Surface equipment, represented at 7, can be of conventional type, and can include a processor subsystem and communicates with the downhole equipment. It is understood that processing can be performed downhole and/or uphole, and that some of the processing may be performed at a remote location. Also, while a wireline is illustrated, alternative forms of physical support and communicating link can be used. The magnetic resonance logging device 30 can have a face 14 shaped to intimately contact the borehole wall, with minimal gaps or standoff. The borehole wall may have a mudcake 16 thereon. A retractable arm 15 is provided that can be activated to press the tool body 13 of tool 30 against the borehole wall during a logging run, with the face 14 pressed against the wall's surface. Although the tool body 13 is shown as a single body, the tool 30 may alternatively comprise separate components such as a cartridge, sonde, or skid, and the tool 30 may be combinable with other logging tools.

The magnetic resonance logging device 30 may include a permanent magnet or permanent magnet array 22, which may, for example, comprise samarium-cobalt magnetic material, and one or more RE antennas 24. The region of investigation, or sensitivity zone, represented generally at 27, is a region in the formation in which the static magnetic field is generally uniform, except for local gradients, although this is not necessarily required for operation in accordance with this disclosure. It is understood that other suitable tool configurations can be used.

A system and method to use Nuclear Magnetic Resonance (NMR) logging in injection, observation, and production wells to monitor carbon dioxide (CO₂) concentrations during CO₂ flooding operations is disclosed. Since common NMR logging tools are only equipped to measure proton NMR, they are not directly sensitive to the presence or concentration of CO₂. However, when CO₂ is mixed with water or oil, it causes those materials to be diluted, thereby lowering their NMR signal intensities. This is equivalent to a negative NMR signal that can be used favorably to monitor de-saturation changes and adjust CO₂ flooding operations, if needed. The carbon/oxygen ratio can also be measured and integrated with the NMR measurements to derive information on carbonic acid saturation and dissolved CO₂ volumes in various fluid phases. (Generally the CO₂ is both dissolved and disassociated. As used herein, the term “dissolved” includes both dissolution and disassociation.)

CO₂ flooding is one common method used for enhanced oil recovery. The technique is considered a “tertiary” recovery technique, meaning it is normally used to extract more oil after a “secondary” recovery technique (e.g., water flooding) has been exhausted and no longer effectively produces oil. In one embodiment, CO₂ at high pressure and high temperature is injected into an injection well. The pressure and temperature are chosen to ensure the CO₂ is in a supercritical state; that is, it is in fluid phase. The fluid CO₂ partly dissolves in the water phase (of the formation fluid) and forms carbonic acid, which in turn causes some dissolution of the carbonate matrix (if in a carbonate formation), but this is not considered the main mechanism of enhanced production from CO₂ flooding. Rather, the majority of the CO₂, which is a non-polar molecule, mixes with the oil phase residing in the pore space of the rock and causes a viscosity and density reduction of the oil, thereby allowing the oil to move through the rock pore space and be produced. To optimize the flooding operation, the CO₂ concentration may be monitored as a function of time and space around the injection well.

Various factors can affect the success of a CO₂ flooding operation. These include, but are not limited to, (1) the relative permeability of the CO₂ fluid in the particular rock comprising the formation; (2) the relative permeability of the oil/CO₂ mixture as a function of a ratio of those two materials; (3) the partition of fluid CO₂ between formation water and formation oil; and (4) the rate of oil recovery as a function of CO₂. Measurement of those parameters is not a trivial task because very few measurement techniques are sensitive to CO₂. For example, the most common logging measurement, resistivity, cannot distinguish between CO₂ and oil since both are electrically non-conductive.

NMR may be used to study some of the above parameters at high pressure and temperature. As stated above, the proton-sensitive NMR tool that is commonly used in the field of oil well logging is not able to directly detect CO₂ because there are no hydrogen atoms in the CO₂ molecule. As a result, no attempts have been made to study CO₂ with this technique.

However, added CO₂ can dilute the oil and/or water phases of the formation fluid, for example, and cause the NMR signal intensity (from the oil and/or water phases) to decrease. In essence, the CO₂ adds a negative intensity to the normal signal and causes a reduced NMR signal that, when compared with the signal before CO₂ injection, provides information about the concentration and flow rate of the injected CO₂.

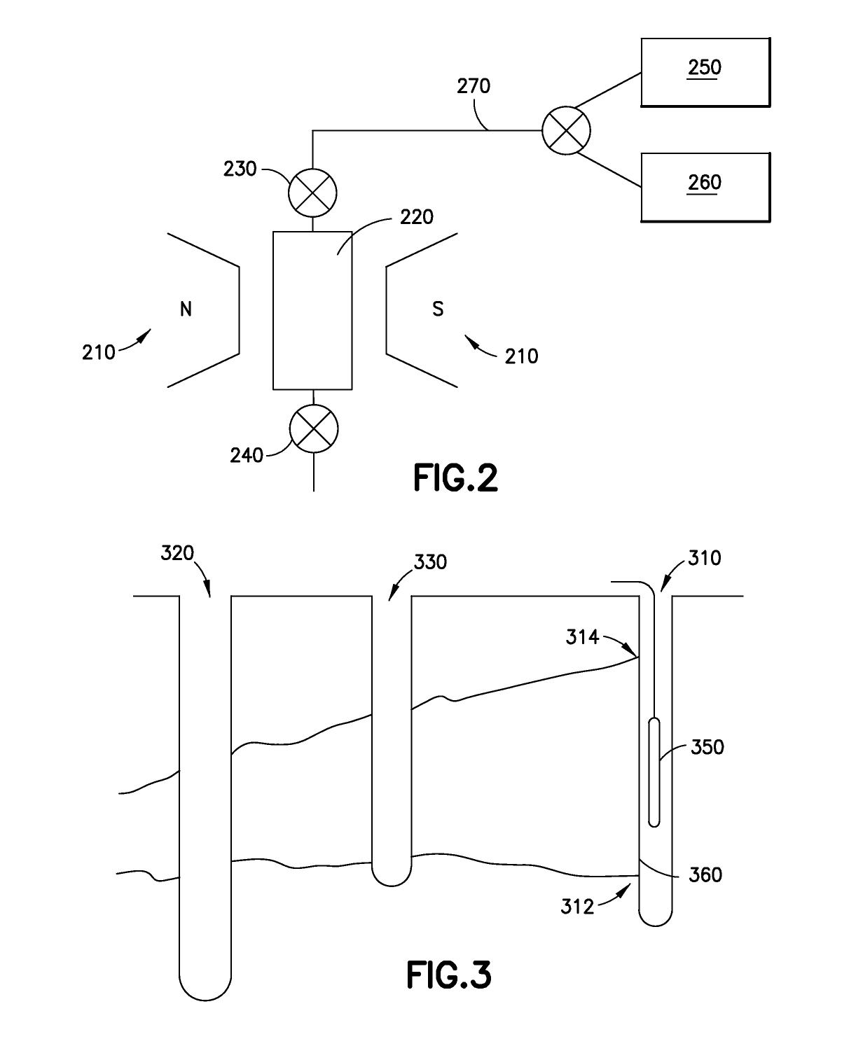

In one embodiment, a laboratory NMR instrument having a high pressure/high temperature (HPHT) sample holder is set up as shown in FIG. 2. In this figure, a magnet 210 having north and south poles is used to align the magnetic moments in the sample. The sample holder 220 is designed to be used under HPHT conditions. The instrument also has an RF coil (not shown), related electronics (not shown), and sample handling instruments such as flow meters, etc. (not shown). Using valves 230, 240 and the tube 270, the sample holder is filled with liquid (e.g., oil or water) having a known initial hydrogen index from a sample reservoir 250, and an NMR signal is measured. (The hydrogen index is the number of protons per unit volume normalized to the same quantity for water. Thus, the hydrogen index of water is one, while that of oil is slightly less than one but varies in a small range depending on the composition of the oil. The NMR signal intensity is proportional to the hydrogen index.) Next, a known volume of supercritical CO₂ fluid (SCC) from reservoir 260 is added to the liquid in the sample holder 220, causing dilution. Diluting the oil or water reduces the respective hydrogen index and thus the NMR signal intensity. This is repeated for a range of SCC fluids, providing data for a look-up table. A plot of NMR signal vs. the volume of SCC such as that shown in FIG. 9 can be made and used to quantify the concentration of SCC based on NMR signal intensity reduction. As FIG. 9 shows, the NMR signal from oil is reduced more than that from water. This is due to the higher solubility of the SCC in oil, as discussed above. The graphs in FIG. 9 can be extended to include the effects of dissolved salt in the water (not shown) and also different pressures and temperatures (not shown).

These measurements can be repeated using a rock core plug that is saturated with oil and/or with water. NMR measurements on the fully saturated core provide a background or control value. Then SCC is injected into the core plug and the NMR signal is measured again. The NMR signal will decrease and the quantified extent of this decrease may be applied to cases in which measurements are performed on the formation, such as the in the example below.

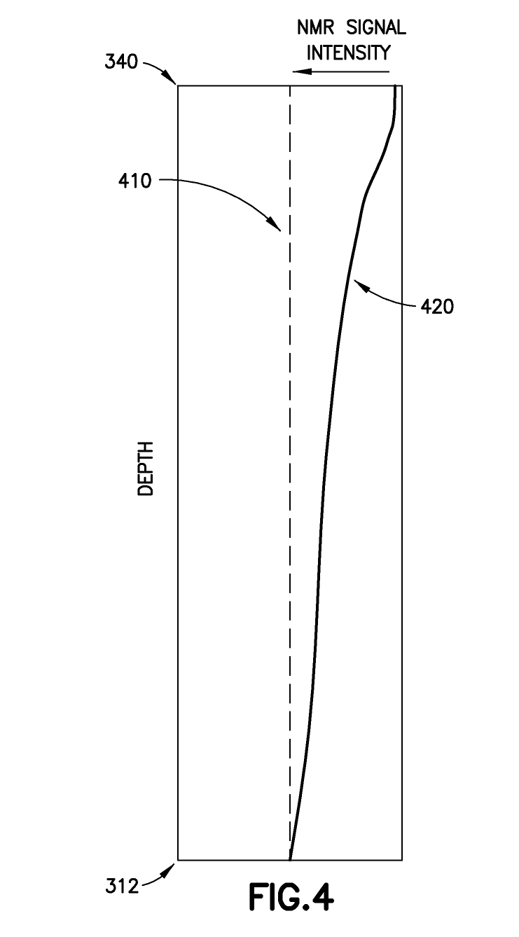

An NMR logging tool making measurements in an injection well may be used to quantify the CO₂ in situ. As shown in FIG. 3, in a field of interest such as an oil field there may be one or more injection wells 310, production wells 320, and monitoring wells 330. In this example an oil bearing layer 340 is selected for production and intersects with the three types of wells. In general, the oil bearing layer 340 may have complex shape that changes in the space between these wells. For example, the layer 340 intersects the injection well in the depth range 312 through 314. The NMR logging tool 350 is used to make an NMR log in the depth range of interest—that is, where the to-be-injected CO₂ is expected to affect the NMR signal. This log 410 is shown in FIG. 4. This is followed by injecting SCC into the formation, below the depth of interest (location generally indicated by figure element 360). Once the SCC has entered the formation, the low density of the SCC causes it to travel toward the top of the formation (i.e., gravity segregation) and accumulate there. The NMR logging tool 350 makes measurements again (shown as log 420 in FIG. 4) over the desired depth range and those measurement results are used to detect the wellbore depth at which the NMR signal is reduced compared to the initial log. In the example of FIG. 4, the NMR signal reduction is maximum at the top of the layer 340 due to gravity segregation while it is progressively less affected as the depth of measurement approaches the bottom (312) of the oil bearing zone 340. The extent of signal reduction demonstrated in FIG. 4 is used in conjunction with the calibration curve(s) generated above to quantify how much SCC is present as a function of wellbore depth.

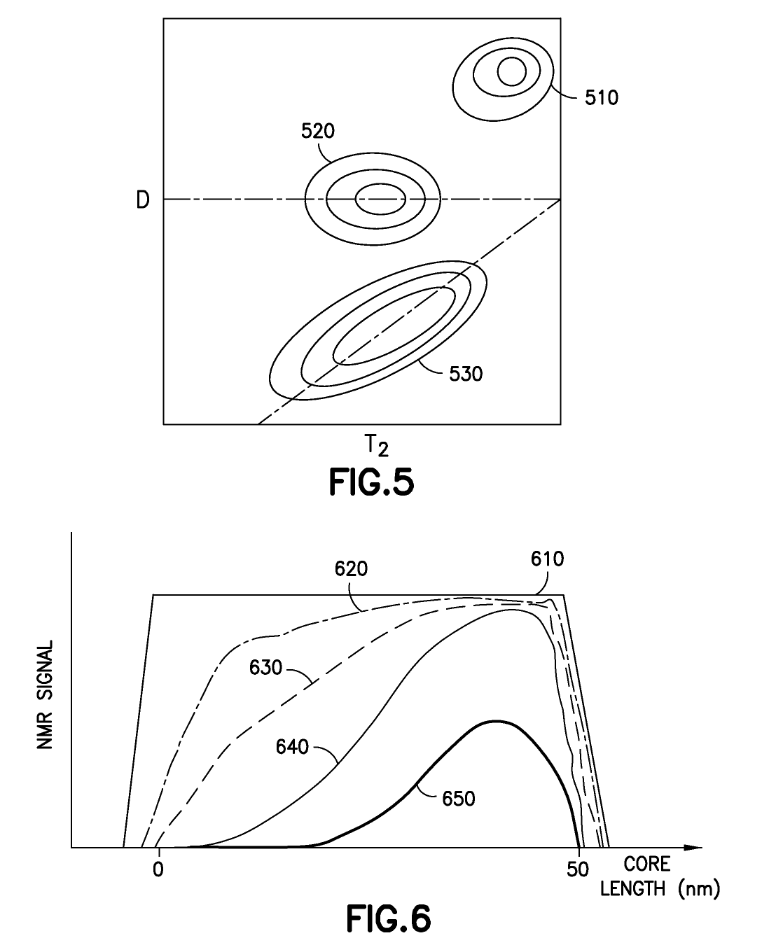

In the field of NMR measurement it is common to separate the measured NMR intensity into the fraction originating from oil and that from water. This is commonly done by measuring diffusion and T2 relaxation of the fluid mixture and generating a two dimensional D-T2 distribution. FIG. 5 shows a typical D-T2 map. The map uses the differences in the diffusion constants of fluid components to separate the total NMR signal into three different zones; the zone at 510 is due to gas (if any), the zone at 520 is due to water, and the zone at 530 is due to oil. The area under these curves is related to the amount of each constituent. Further, since the NMR measurement can be partitioned into the part that originated from water and the part that originated from oil, it is possible to calculate the partition of the CO₂ between water and oil. Before injecting CO₂ a map similar to that shown in FIG. 5 is produced from measurements. Next CO₂ is injected and NMR is measured, leading to one or a series of maps similar to that shown in FIG. 5. Each map is used to obtain information about the fluids in the mixture before, after, or during the CO₂ injection. This information is used to extract the fluid flow properties of the SCC, SCC+oil, and SCC+water phases.

Some low frequency laboratory and downhole NMR instruments are equipped to produce “one-dimensional” NMR images. In this case, an external magnetic field gradient is provided that varies the static (DC) magnetic field along the axial length of the core sample (i.e., for a lab sample or region of investigation in a wellbore, produces a non-homogeneous static field over the axial length of the sample). The gradient may arise naturally from an inherent reduction in field strength with distance from the magnetic source, or it may be expressly generated using additional magnetic sources such as one or more electric coils (“gradient coils”). Thus, each point (i.e., NMR signal source) in a plane perpendicular to the sample axis resonates at a different Larmor frequency than points (e.g., hydrogen protons) in other such planes. Therefore, when a particular frequency is sampled, one knows the resulting NMR signal is from a corresponding axial location on the sample. As a result, the NMR signal as a function of location along the length of the core sample may be obtained and imaged along one axis (i.e., 1-D imaging).

By “imaging”, we mean a collection of measurements made at different depths of investigations (DOIs). Certain NMR tools, such as those having no explicit gradient-generating device (i.e., no coils, but instead rely on natural fall-off of field strength with distance), may be programmed to produce a set number (e.g., four) of depths of investigation. However, other NMR tools, particularly those with explicit gradient-generating devices, can have a higher radial resolution (i.e., greater number of DOIs).

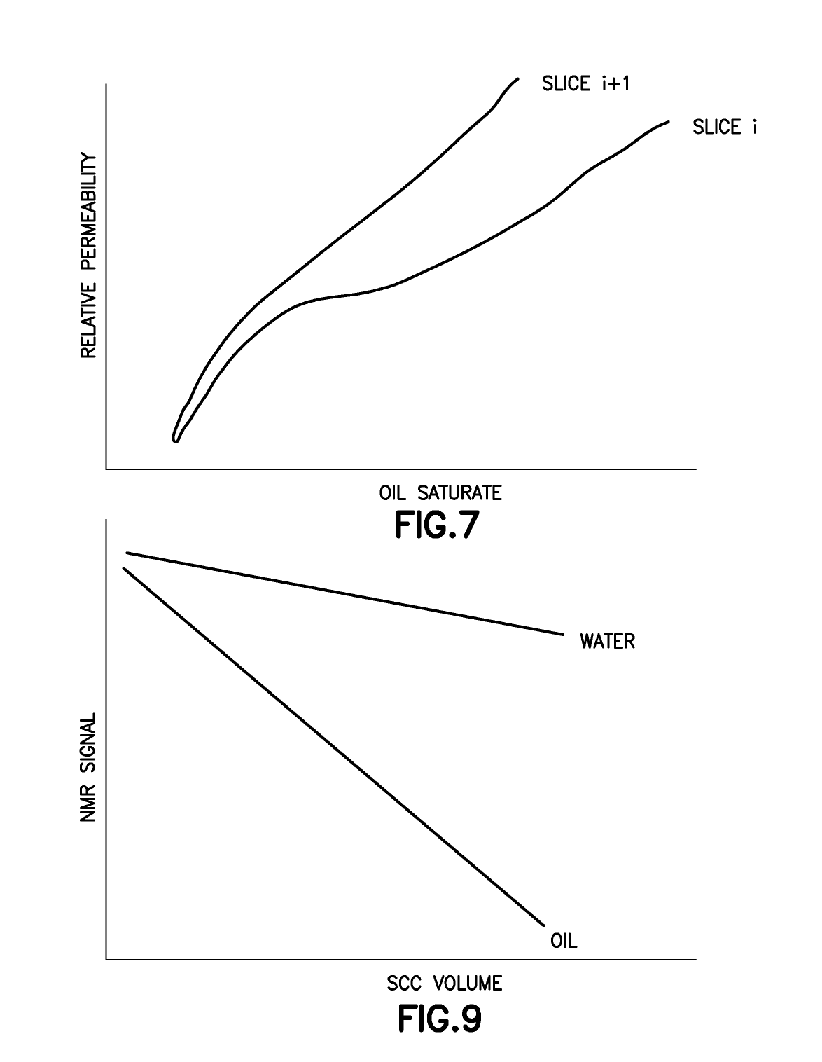

The image can have an axial resolution of 1 mm or less. Thus, a standard 50 mm long rock sample can be imaged into at least 50 slices with known NMR signal intensities (or T2 distributions) before injection of any SCC, as shown in FIG. 6. In FIG. 6 a core sample of 50 mm is depicted along the horizontal axis and the NMR signal measured at each 1 mm slice is plotted on the vertical axis. The initial signal 610 has a constant intensity along the length of the core as the core is assumed to be fairly homogeneous; if there is inhomogeneity in the core, it shows up as variation on the NMR signal. Once the SCC is injected, the imaging measurements are repeated. The results for four times of SCC injection are shown in FIG. 6 as traces 620-650. Assuming the SCC injection is from the end designated as zero on the horizontal axis, the trace 620 shows a reduction in the NMR signal around the zero point with no effect on the opposite end (50 mm end). As the time of injection increases, more and more of the NMR signal from the zero end decreases and signal loss extends closer to the 50 mm end. Those results allow one to map the rate of SCC movement along the length of the core plug. Knowing the flow rate of the SCC and the initial pressure difference across the sample (which is set and therefore known), Darcy's relation can be used to calculate the SCC relative permeability. This process can be repeated for various mixtures of water and oil (i.e., different water saturations) and for each case various amounts of SCC. The results may be plotted in a plot similar to FIG. 7 as relative permeability curves for SCC corresponding to different water or oil saturations in a particular type of rock. The relative permeability will change as a function of location and properties of each slice. In FIG. 7 two slices (i and i+1) are shown.

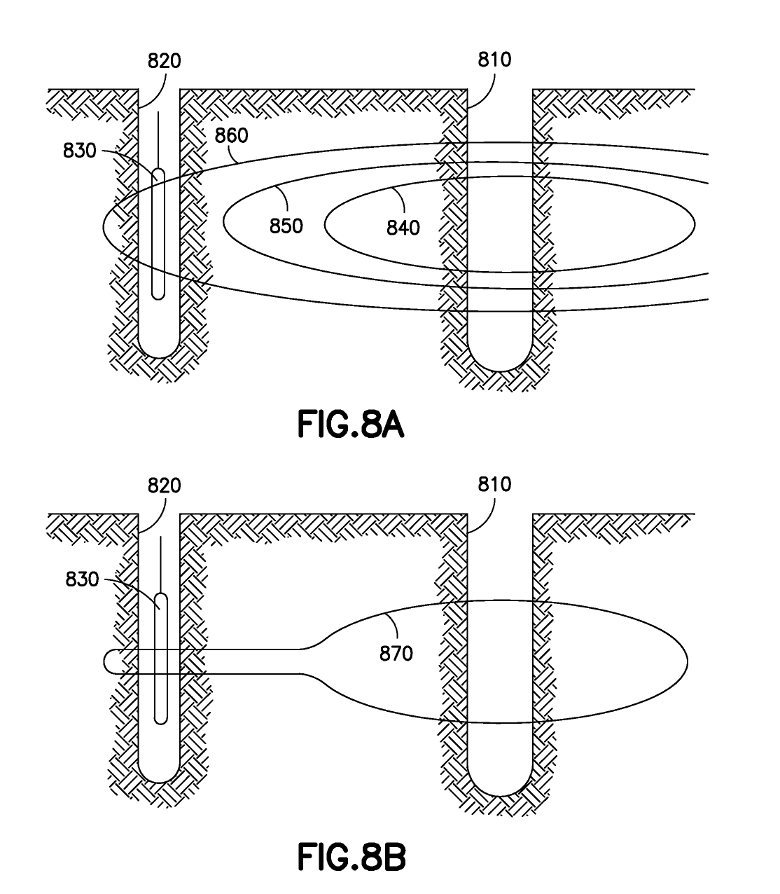

The above-determined relative permeability can be used to calculate the expected time it takes for a known volume of SCC to travel from an injection well to one or more observation or production wells. This is shown in FIG. 8A, in which an injection well 810 and an observation or monitoring well 820 are shown. The SCC is injected from the injection well 810 and travels roughly symmetrically if the formation is homogeneous. The SCC flow paths are symmetric around the injector well 810, as indicated by contour lines 840, 850, 860. The earliest injected SCC, indicated by contour 860, has reached the observation well 820. The time it takes for the SCC to flow from injection well 810 to monitoring well 820 should be consistent with what is expected from the above-measured relative permeability. As CO₂ is injected into the injection well, an NMR logging tool 830 may be disposed in any desired observation or production well to monitor the arrival of the SCC via the corresponding NMR signal reduction. As the SCC spreads in the formation, it may travel differently depending on the nature of the rock formation. For example, as stated above, in homogeneous formations it tends to spread cylindrically, with the radius of the cylinder increasing as time passes and the SCC concentration diminishing as a result. The extent of this dilution can be calculated and compared with actual measurements when the SCC reaches the monitoring well 820 or production well.

FIG. 8B, on the other hand, shows a case where a channeling mechanism such as a high permeability streak in the formation has caused the injected SCC to reach the observation well 820 and be measured by the NMR tool 830. In this case the expected arrival of the SCC in observation well 820 is longer than that measured, indicating some deviation from the assumed homogenous permeability assumption used to calculate the expected arrival time. Similarly, other scenarios are possible in which the SCC arrives in observation well 820 (or a production well) much later (not shown). This would also produce a deviation from the expected time of arrival. A deviation from the expected value implies non-uniform spreading, which can be verified if measurements from azimuthally-offset observation or production wells are available. Those measurements can also be used to quantify the extent of the non-uniformity which is used to map potentially bypassed production zones.

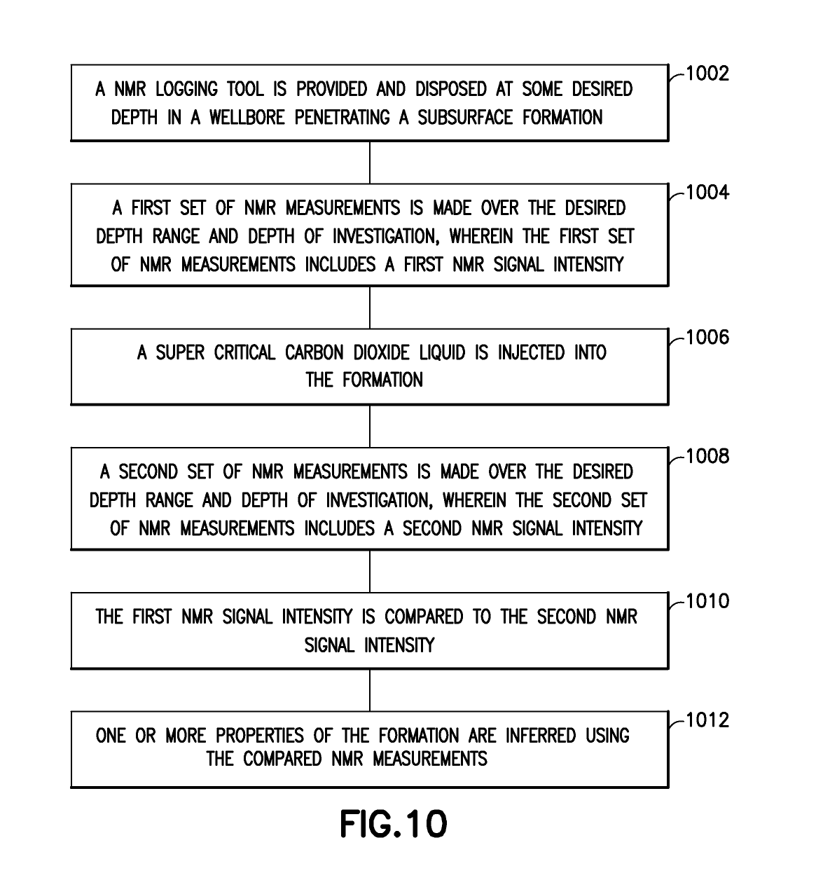

FIG. 10 is a flowchart for one embodiment to infer one or more properties of a formation using one or more NMR measurements. A NMR logging tool is provided and disposed at some desired depth in a wellbore penetrating a subsurface formation (1002). A first set of NMR measurements is made over a desired depth range and depth of investigation, wherein the first set of NMR measurements includes a first NMR signal intensity (1004). A supercritical carbon dioxide fluid is injected into the formation (1006) and, a second set of NMR measurements is made over the desired depth range and depth of investigation, wherein the second set of NMR measurements includes a second NMR signal intensity (1008). The first NMR signal intensity is compared to the second NMR signal intensity (1010). One or more properties of the formation are inferred using the compared NMR measurements (1012).

Some of the methods and processes described above, including processes, as listed above, can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, or general purpose computer) for executing any of the methods and processes described above.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Some of the methods and processes described above, as listed above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

While the embodiments described above particularly pertain to the oil and gas industry, this disclosure also contemplates and includes potential applications such as underground environmental spill monitoring and clean-up where either air, N₂, CO₂, or some other non-protonic agent is used. (That is, an agent that does not produce a NMR signal and thereby affects the NMR response similar to the manner in which CO₂ does.) As used herein, the phrase “supercritical carbon dioxide” may include all such non-protonic agents.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the scope of the present disclosure, and that they may make various changes, substitutions, and alterations herein without departing from the scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

While only certain embodiments have been set forth, alternatives and modifications will be apparent from the above description to those skilled in the art. These and other alternatives are considered equivalents and within the scope of this disclosure and the appended claims. Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method, comprising:
providing a nuclear magnetic resonance (NMR) logging tool and disposing the NMR logging tool at some desired depth in a wellbore penetrating a subsurface formation;
making a first set of NMR measurements over a desired depth range and depth of investigation, wherein the first set of NMR measurements includes a first NMR signal intensity;
injecting supercritical carbon dioxide into the formation;
making a second set of NMR measurements over the desired depth range and depth of investigation, wherein the second set of NMR measurements includes a second NMR signal intensity;
comparing the first NMR signal intensity to the second NMR signal intensity; and
inferring one or more properties of the formation using the compared NMR signal intensities.

2. The method of claim 1, wherein the wellbore penetrating a subsurface formation is selected from the group consisting of an injection well, a production well, and a monitoring well.

3. The method of claim 1, wherein the one or more properties of the formation are selected from the group consisting of: formation permeability; formation fluid characterization; relative permeability of a water/carbon dioxide mixture in the formation; relative permeability of an oil/carbon dioxide mixture in the formation; partition of the carbon dioxide between formation water and formation oil; rate of oil recovery as a function of carbon dioxide concentration; and carbon dioxide concentration.

4. The method of claim 1, wherein the comparing further comprises:
quantifying the magnitude of the first NMR signal intensity relative to the magnitude of the second NMR signal intensity.

5. The method of claim 1, further comprising:
monitoring de-saturation changes in formation fluids; and adjusting a carbon dioxide flooding operation according to the ascertained de-saturation changes.

6. The method of claim 1, wherein the injected supercritical carbon dioxide mixes with formation fluids.

7. The method of claim 6, wherein the mixed carbon dioxide dilutes the formation fluids.

8. The method of claim 7, wherein the diluted formation fluids move through the formation.

9. The method of claim 7, wherein the diluted formation fluids produce reduced NMR signal intensities.

10. The method of claim 1, further comprising:
determining a carbon/oxygen ratio using a nuclear logging tool;
integrating the determined carbon/oxygen ratio with the first and/or second sets of NMR measurements; and
determining carbonic acid saturation and/or dissolved carbon dioxide volumes in one or more formation fluid phases.

11. The method of claim 1, further comprising using a laboratory NMR instrument to make one or more baseline NMR measurements.

12. The method of claim 11, wherein the one or more baseline measurements are made on a sample selected from the group consisting of: a rock sample; a rock sample injected with supercritical carbon dioxide; a water sample; an oil sample; a water/carbon dioxide mixture sample; and an oil/carbon dioxide mixture sample.

13. The method of claim 1, wherein the one or more inferred formation properties provide information relevant to environmental spill remediation.

14. The method of claim 13, wherein the supercritical carbon dioxide is replaced by a non-protonic agent selected from the group consisting of air and nitrogen.

15. The method of claim 1, wherein the wellbore is an observation well or a production well;
and further comprising inferring whether a flow pattern of the carbon dioxide is uniform or non-uniform based on a determined relative permeability and the NMR measurements made by the NMR logging tool.

16. The method of claim 15, further comprising using an ascertained reduction in NMR signal intensity to infer an arrival of the carbon dioxide at the observation well or the production well.

17. The method of claim 15, wherein the non-uniformity of the flow pattern is used to discern possible bypassed production zones.

18. A method, comprising:
nuclear magnetic resonance (NMR) logging tool and disposing the NMR logging tool at some desired depth in a wellbore penetrating a subsurface formation;
providing a magnetic field gradient that varies a static magnetic field along a desired spatial dimension of a region of investigation by the NMR logging tool;
making a baseline set of imaging data;
injecting supercritical carbon dioxide into the region of investigation to produce a diluted region of investigation;
making one or more additional sets of imaging data;
mapping the rate of movement of the injected carbon dioxide along the desired spatial dimension; and
inferring one or more properties of the region of investigation using the mapped rate of movement of the carbon dioxide.

19. The method of claim 18, further comprising correlating a specific locus of NMR signal sources to a specific volume within the region of investigation.

20. The method of claim 19, further comprising correlating each specific locus of NMR signal sources to specific locations along the desired spatial dimension of the region of investigation.

21. The method of claim 19, further comprising producing a one-dimensional image along the desired spatial dimension of the region of investigation.

22. The method of claim 18, wherein the inferring one or more properties of the region of investigation comprises determining a supercritical carbon dioxide relative permeability using the mapped rate of movement and an initial pressure difference across the region of investigation.

23. The method of claim 18, wherein the wellbore is an observation well or a production well; and further comprising inferring whether a flow pattern of the carbon dioxide is uniform or non-uniform based on a determined relative permeability and the NMR measurements made by the NMR logging tool.

24. A system, comprising:
a nuclear magnetic resonance (NMR) logging tool disposed at some desired depth in a wellbore penetrating a subsurface formation;
a source of supercritical carbon dioxide or other non-protonic agent; and
a processor located at the earth's surface or carried on the NMR logging tool capable of:
making a first set of NMR measurements over a desired depth range and depth of investigation, wherein the first set of NMR measurements includes a first NMR signal intensity;
injecting the supercritical carbon dioxide or other non-protonic agent into the formation;
making a second set of NMR measurements over the desired depth range and depth of investigation, wherein the second set of NMR measurements includes a second NMR signal intensity;
comparing the first NMR signal intensity to the second NMR signal intensity; and
inferring one or more properties of the formation using the compared NMR signal intensities.
